(19) United States
(12) Patent Application Publication
(10) Pub. No.: US 2026/0027662 A1
(43) Pub. Date: Jan. 29, 2026

(54) MOTORIZED CONVEYOR CART WITH CONTROLLER

(71) Applicant: Structural Services, Inc., Bethlehem, PA (US)

(72) Inventors: James T. Benzing, Bethlehem, PA (US); David W. Eckhart, II, Allentown, PA (US); Sam Fowler, Hopewell, NJ (US); Nicholas D. Caiazzo, Bath, PA (US); Henry Burd, Bethlehem, PA (US)

(73) Assignee: Structural Services, Inc., Bethlehem, PA (US)

(21) Appl. No.: 19/278,648

(22) Filed: Jul. 23, 2025

Related U.S. Application Data
(60) Provisional application No. 63/674,572, filed on Jul. 23, 2024.

(51) Int. Cl. B23K 37/02; B23K 31/02; B25J 11/00

(52) U.S. Cl. CPC B23K 37/0258; B23K 37/0247; B23K 37/0282; B25J 11/0065; B23K 31/02

(57) ABSTRACT

The invention provides a system for controlling the movement of a motorized cart on which a stud welder or grinder is mounted. The system comprises a speed control mechanism, distance control mechanism, and delay time control mechanism, each adjustable via potentiometer knobs. Directional control is managed by first and second three-way momentary switches and a three-way maintained switch for precise track movements. An LCD screen displays real-time settings, while an integrated power switch and wireless RF transmitter facilitate operation and communication with motor controllers. The custom software codebase ensures intuitive user adjustments. The method includes initializing the system, setting parameters, and controlling movement and operations via the interface. Additionally, an advanced ride cart system is described, featuring a lightweight composite body, touch-sensitive controls, safety features, and a high-capacity battery.

### BACKGROUND OF THE INVENTION

The present invention relates to motorized carts designed to transport equipment used for welding shear studs for elevated concrete slabs installed on metal decking (hereinafter “shear stud installation equipment”). Functionality that may be provided by shear stud installation equipment includes grinding weld locations, loading studs (and optionally ferrules) into a welding gun, supporting the welding gun, placement of ferrules at welding locations, executing the welding of studs, and removing ferrules after stud welding. Such shear studs are used in steel erection projects such as bridge and building construction or other applications having elevated concrete slabs supported by corrugated deck pans.

Installing shear studs is a labor-intensive and back-breaking job. Conventional motorized carts enable the use of labor-saving shear stud installation equipment, which is typically heavier than conventional manual equipment. Conventional motorized carts must be manually moved as the cart-mounted shear stud installation equipment is being used. For example, it may be desirable to move the cart each time a certain number of weld spots have been ground (in the case of a cart-mounted stud grinder) or after a certain number of studs have been welded (in the case of a cart-mounted stud loader). This requires the person operating the shear stud installation equipment to stop using the shear stud installation equipment and manually activate cart movement controls or that a second person be available to activate the cart movement controls. Accordingly, there is a need for a more automated means of moving a motorized cart having shear stud installation equipment.

### OBJECTS OF THE INVENTION

Some of the objects of the present disclosure, which at least one embodiment herein satisfies, are as follows.

An object of the present disclosure is to provide a method and system for controlling the movement of a motorized cart carrying surface grinding and stud welding equipment with high precision.

Another object of the present disclosure is to enable fine adjustments of the cart's speed using a potentiometer knob, measured in feet per minute (ft/min).

Still another object of the present disclosure is to allow precise control over the movement distance of the motorized cart through a dedicated potentiometer knob, measured in inches.

Another object of the present disclosure is to facilitate the setting of specific delay times between movements using a potentiometer knob, measured in seconds.

Still another object of the present disclosure is to offer directional control via three-way momentary and maintained switches for both individual and synchronized track movements.

Still another object of the present disclosure is to incorporate real-time monitoring of speed, distance, and delay time settings via an LCD screen.

Yet another object of the present disclosure is to enhance the ease of use and flexibility by integrating wireless RF communication between the controller and motor controllers.

Yet another object of the present disclosure is to provide a user-friendly interface through a custom software codebase, allowing intuitive adjustments to the operational parameters of the cart.

Other objects and advantages of the present disclosure will be more apparent from the following description, which is not intended to limit the scope of the present disclosure.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

The present invention is generally directed a system and method for automatically controlling the movement of a motorized cart on which shear stud installation equipment in mounted. The control system enables a user to select cart automated movement parameters including the direction of movement, the distance of each movement, and at least one movement trigger. Optionally, the control system may also enable a user to select the speed at which the cart moves during each movement. Each movement trigger is an event that causes the cart to move the user-selected distance in the user-selected direction.

In some exemplary implementations, the cart may include rubber tracks, which provide stability over corrugated decking. In many exemplary implementations, the automatic movement control will only allow for linear movement (i.e., in a straight line). In addition, the cart preferably also includes manual movement controls, which enable the user to move the cart manually in a full range of movement, including linear movement, turning, and rotation.

A user-selected time delay is one example of a movement trigger. The control system may provide a user-selectable time delay between movements. Another example of a movement trigger is a sensor and a user-selectable number of times that sensor changes state. For example, the control system could provide a user-selectable number-representing the number of rows of studs to be welded. Sensor could be provided on a stud loader is mounted on the cart that detects each time a stud is loaded into a stud welding gun. Each time the controller detects that a number of studs have been loaded that equals the number of rows selected by the user, a cart movement is activated.

An exemplary control system may include a distance adjustment selector and distance display (in units of distance, such as inches), speed selector for selecting the cart's speed (e.g., in units of feet per minute), a time delay selector for adjusting time delay between movements (e.g., in seconds). Additionally, three-way momentary and maintained switches provide enhanced manual movement control, allowing for both individual and synchronized track movements to improve efficiency.

Real-time monitoring is facilitated by an LCD screen that displays current settings, enabling immediate adjustments and verification. Wireless communication between the controller and motor controllers is achieved through an internal RF transmitter, eliminating the need for physical wiring and enhancing mobility. The system is complemented by user-friendly software that offers an intuitive interface, simplifying adjustments and minimizing the need for extensive training, thus ensuring precise control and improved operational efficiency.

### BRIEF DESCRIPTION OF THE DRAWINGS

So that the manner in which the above recited features of the present invention can be understood in detail, a more particular description of the invention, briefly summarized above, may have been referred to by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein

FIG. 1 is a perspective view of an implementation of a motorized conveyor cart for supporting equipment for grinding welding sites on structural I-beams shown positioned over a corrugated deck pan of a construction site;

FIG. 2 is a perspective view of an implementation of a motorized conveyor cart for supporting a shear stud welding gun and related equipment shown positioned over a corrugated deck pan of a construction site;

FIG. 3 shows several schematic diagrams illustrating operation of the motorized conveyor cart in accordance with an implementation;

FIG. 4 is detail view of a controller utilized as part of the motorized conveyor cart in accordance with an implementation;

FIG. 5 is a flow chart illustrating operation of the motorized conveyor cart in accordance with an implementation;

FIG. 6 is a detail view of a controller of an alternative system for controlling the movement of a motorized cart carrying surface grinding and stud welding equipment in accordance with an implementation;

FIG. 7 is another detail view of the controller of the alternative control system;

FIGS. 8A and 8B collectively illustrate a logic flow diagram for the alternative control system, according to one implementation.

FIG. 9 shows details of a stud welding detection module of the alternative control system in accordance with an implementation; and,

FIG. 10 illustrates control and signal architecture for the alternative control system.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

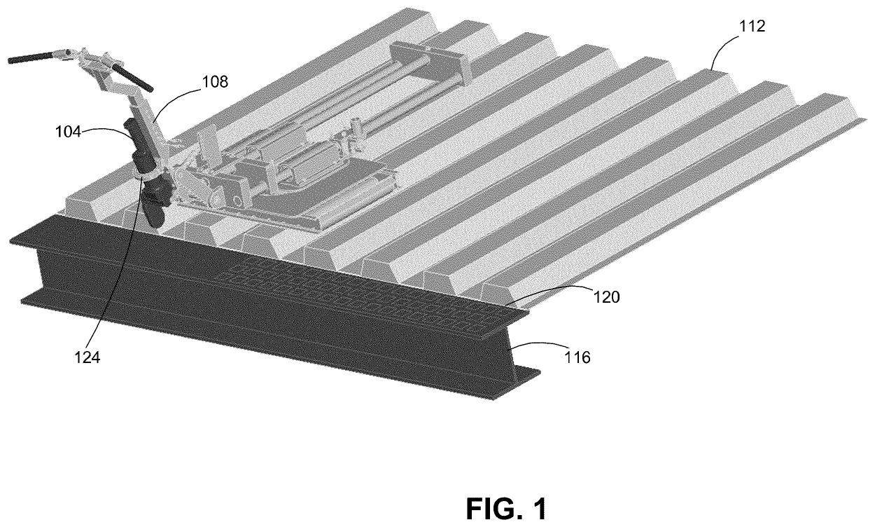

As shown in FIG. 1, in one implementation, a motorized conveyor cart 100 is shown supporting a hand-held grinding tool 104 and related assistive equipment 108 used to grind surface residue from pre-defined welding sites on structural I-beams used in bridge and building construction. The motorized conveyor cart 100 is shown positioned on a corrugated deck pan 112 and adjacent a conventional steel I-beam 116. The deck pan 112 and I-beam 116 may be utilized in the construction of buildings and bridges. It is common for the deck pan 112 to include sequential peaks and valleys, as it is configured to hold poured concrete that eventually forms a floor such as a building floor. The I-beam 116 may include a planar top surface 120 having the welding sites that must be prepared in advance of welding the shear studs 128 thereto. The target welding sites may be equally spaced along the length of the I-beam 116. The motorized conveyor cart 100 may be sized and shaped to carry the grinding equipment 104, 108 and arranged to traverse the peaks and valleys of the corrugated deck pan 112 to eliminate the need for an operator to manually transport the grinding equipment 104, 108 as the operator moves to subsequent grinding sites along the I-beam 116, thus reducing manual effort.

The motorized conveyor cart 100 may be constructed of any suitable materials such as lightweight, reinforced composite materials. These materials are chosen for their high strength-to-weight ratio, which ensures durability while minimizing the overall weight of the cart. The use of such materials improves the cart's maneuverability and energy efficiency, making it easier to handle and more environmentally friendly.

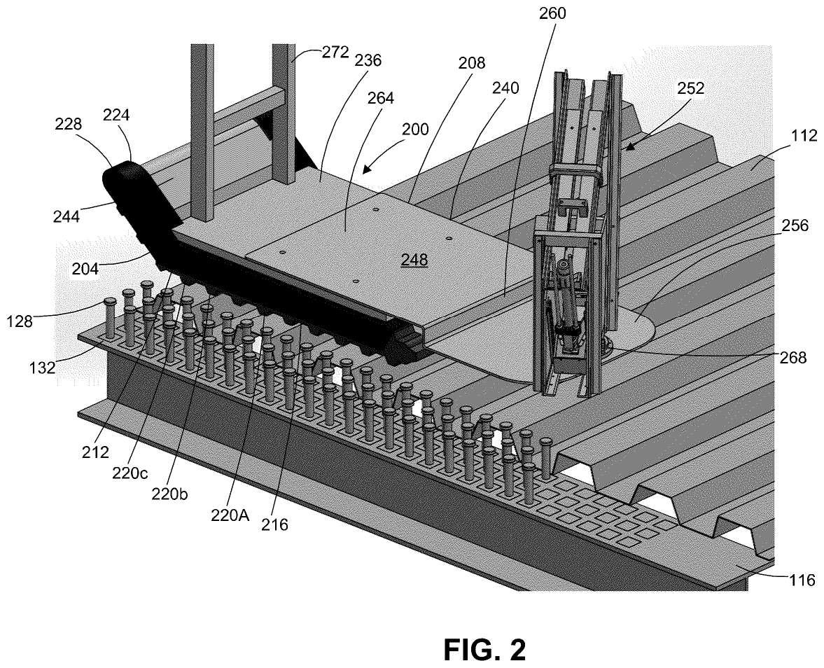

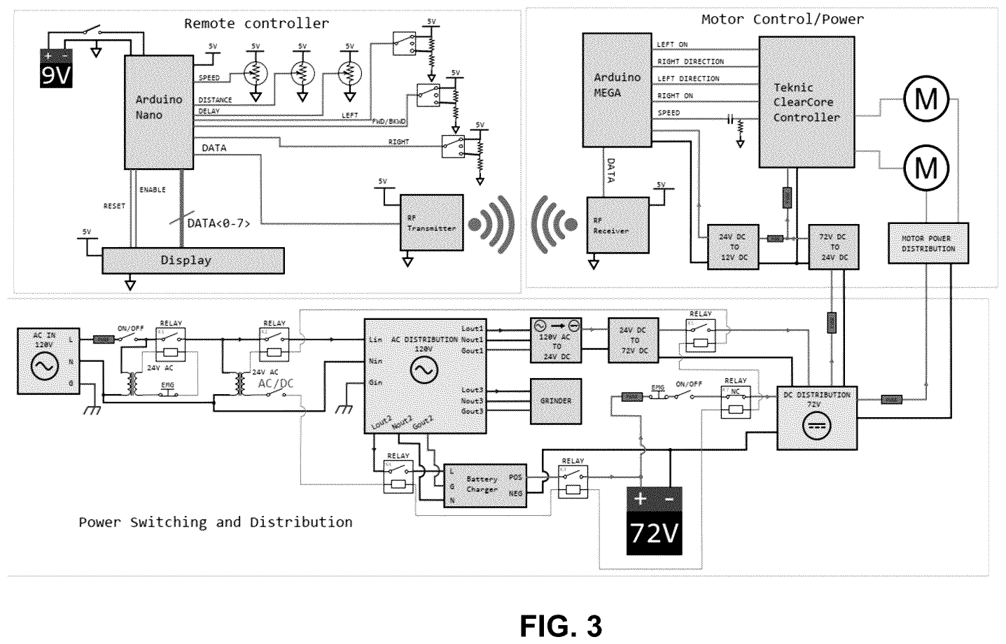

As shown in FIG. 2, after grinding, shear studs 128 are manually welded to the pre-defined welding sites on the planar top surface 120 of the I-beam 116 using a shear stud welding gun (not shown). Ceramic ferrules 132 are placed at the pre-defined welding sites, and one at a time, shear studs 128 are placed with the tip inside the ferrules 132 for welding to the surface of the I-beam 116. To eliminate the need for manually loading shear studs 128 into the collet of the shear stud welding gun, a shear stud loader 252 is provided. The shear stud loader 252 may be supported on the motorized conveyor cart 100 arranged to traverse the peaks and valleys of the corrugated deck pan 112 during the welding process to eliminate the need for an operator to manually transport the shear stud loader 252 as she/he moves to subsequent welding sites along the I-beam 116, thus reducing manual effort.

The motorized conveyor cart 100 may include a first drive assembly 204 and a second drive assembly 208. The first drive assembly 204 is capable of acting independently of the second drive assembly 208 for the purpose of allowing the cart 100 to rotate in a clockwise and counterclockwise manner with respect to a vertical axis as deemed necessary by the operator while moving over the corrugated deck pan 112, a surface of a bridge, or any other supporting surface.

By way of example, FIG. 2 shows the motorized conveyor cart 100 traversing a corrugated deck pan 112. As discussed below, the rotational mounting of the shear stud loader 252 to the motorized conveyor cart 100 via a turntable 268 allows the operator to adjust the rotational position of the shear stud loader 252 anywhere between the opposing side edges of the corrugated deck pan 112.

The first drive assembly 204 may be located on a first side 212 of the motorized conveyor cart 100 and may include a first tread 216, which may be made of rubber or any other suitable material. The first tread 216 extends along and engages several drive sprockets 220a, 220b, and 220c of the first drive assembly 204 for the purpose of maintaining the alignment of the first tread 216. The drive sprockets 220a, 220b, and 220c of the first drive assembly 204 are coupled to a first motor 224, which may be a brushless DC motor, through a first gearbox 228. The first motor 224 is electrically coupled to a motor controller 232. The motor controller 232 is operably connected to, and receives electrical power from, a battery system 236.

The second side 240 of the motorized conveyor cart 100 may also include a second drive assembly 208 that is similar to the first drive assembly 204. The second drive assembly 208 may include a second rubber tread (not shown) which extends along and engages with second drive sprockets (not shown) for the purpose of maintaining the alignment of the second rubber tread. The second drive sprockets may be coupled to a second motor, which may be a brushless DC motor, through a second gearbox. The second motor may also be operably and electrically coupled the motor controller 232.

The first drive assembly 204 and the second drive assembly 208 are physically coupled and aligned through a mechanical chassis 244, which may also be physically coupled to the top mounting plate 248. In addition, the motor controller 232 may be physically coupled to top mounting plate 248. Further, an angled or bent front mounting plate 244 may be physically coupled to the top mounting plate 248 through one or more mounting holes. The shear stud feeder 252 may be mounted to an offset front portion 256 of the top mounting plate 248. The offset front portion 256 connects to the top mounting plate 248 via a downward bend 260. This allows the shear stud feeder 252 to be positioned below a top surface 264 of the top mounting plate 248 and above the top surface of the corrugated deck pan 112 or alternative surface where the shear stud welding is occurring and upon which the first tread 216 and second tread (not shown) are moving. The offset front portion 256 also allows the relative height of the shear stud feeder 252 to be decreased in order to decrease the relative height at which a shear stud welding gun must be raised for stud loading to occur, which improves operator comfort.

The shear stud feeder 252 may be mounted to the offset front portion 256 of the top mounting plate 248 via a turntable 268 that is positioned on the offset front portion 256. The turntable 268 allows the shear stud feeder 252 to be rotatably adjusted with respect to the offset front portion 256, which in turn allows the operator to rotate the shear stud feeder 252 to align with the location of stud placement on the shear stud welding site. FIG. 2 shows one possible orientation of the shear stud feeder 252 as the turntable 268 is moved to a desired position. As shown in FIG. 2, the turntable 268 allows the operator to position the shear stud loader 252 over shear studs located on either side of a corrugated deck surface 112 or other type of supporting surface.

The motorized conveyor cart 100 may also include a height-adjustable handle 272 which physically couples to the top mounting plate 248. The height-adjustable handle 272 may be operably connected to the motor controller 232. The motor controller 232 allows the operator to control the motion of the motorized conveyor cart 100, including but not limited to its speed and direction of directional motion.

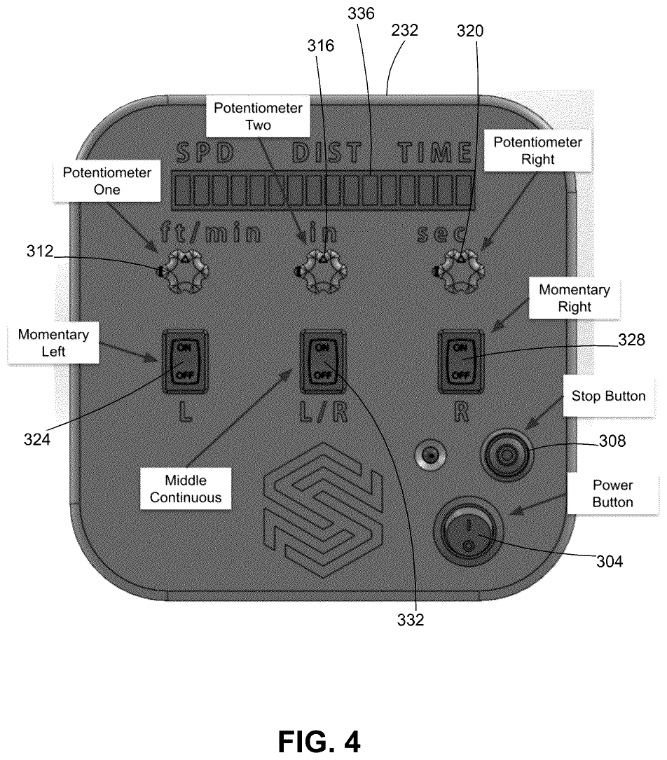

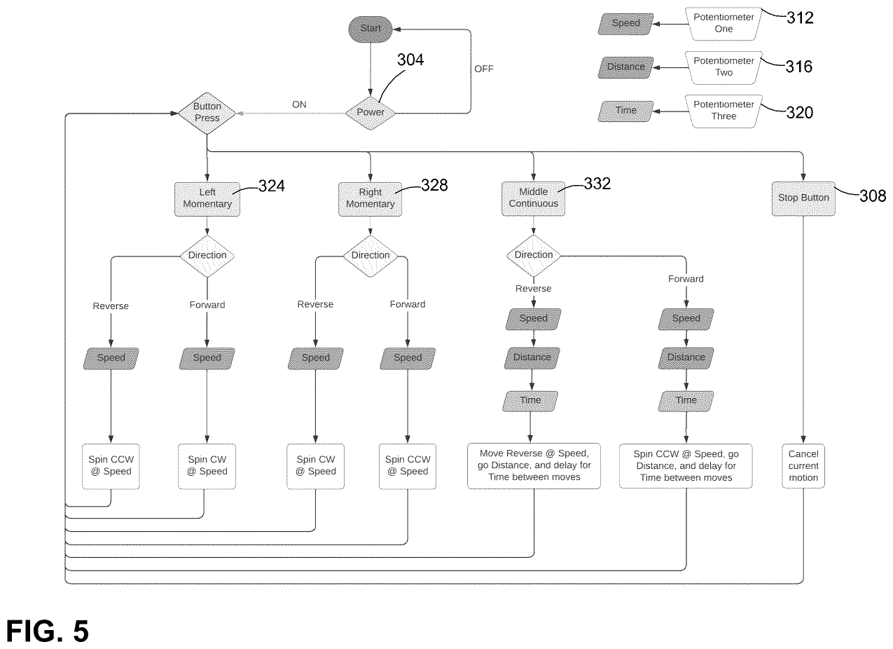

Referring now to FIGS. 4 and 5, the motor controller 232 is provided with operator controls for controlling movement of the motorized conveyor cart 100 during use of the shear stud feeder 252 or grinding equipment 104, 108 as the operator moves along the pre-defined welding sites on the I-beam 116. The motor controller 232 may include a leftmost potentiometer knob 312 labeled “Potentiometer One” for controlling the velocity of the motorized conveyor cart 100 as it moves along the deck pan 112. The potentiometer knob 312 enables an operator to set the speed in feet per second but other units of measure could be employed. The motor controller 232 may also include a centrally located potentiometer knob 316 labeled “Potentiometer Two” to set and control the precise distance of movement of the cart 100. For example, the distance of movement may be determined based upon the distance between the pre-defined sites on the I-beam 116 for grinding and welding. For example, the potentiometer knob 316 enables the operator to set the distance of movement in inches, but other units of measure could be employed. The motor controller 232 may also include a right potentiometer knob 320 labeled “Potentiometer Three” for determining an amount of time delay, e.g., in seconds. This enables the operator to delay movement of the cart 100 for a sufficient period of time, for example, to enable completion of a grinding or welding process at a pre-defined welding site before moving on to the next site. In this manner, the cart 100 moves at a speed that is comfortable for the operator for completion of each grinding or welding operation.

The motor controller 232 may also include a left momentary switch 324 to control movement of the first drive assembly 204. The left momentary switch 324 may be a three-way switch for controlling forward, neutral, and backward movement of the first drive assembly 204. Actuation of the left momentary switch 324 will activate the first drive assembly 204 only, causing either clockwise or counterclockwise rotation of the motorized conveyor cart 100 depending upon whether forward or backward movement is selected. Likewise, a right momentary switch 328 may be provided, e.g., a three-way switch for controlling forward, neutral, and backward movement of the second drive assembly 208. Actuation of the right momentary switch 328 will activate the second drive assembly 208 only, causing either clockwise or counterclockwise rotation of the motorized conveyor cart 100 depending upon whether forward or backward movement is selected. A maintain switch 332 may also be provided to enable the operator to simultaneously control the forward and backward movement of the first and second drive assemblies 204, 208 causing the motorized conveyor cart to travel in a linear or non-linear direction at a predetermined speed set by the operator to allow the operator to use the shear stud feeder or grinding equipment without needing to adjust the position of this equipment as the operator moves from one pre-defined welding site to the next on the I-beam 116.

The motor controller 232 may communicate wirelessly with the first and second drive assemblies 204, 208 to ensure the receipt of accurate commands without the need for wired connections.

An LED screen display 336 may be provided, which may display the current settings including speed, distance, and/or time delay, and other statuses of the motorized conveyor cart 100 for the operator. This real-time feedback ensures that the operator can continuously monitor and adjust the settings to maintain optimal operational parameters. The motor controller 232 may also include a power on/off button 304 for actuating the motor controller 232 and a stop button 308 to stop the current movement of the cart 100. In this way, the motorized conveyor cart 200 is actuated through the motor controller 232 eliminates the need for manual operator transportation of the shear stud feeder system or the manual grinding system, thus decreasing the physical strain on the operator as the operator moves from one predetermined location to the next along the I-beam.

### Method for Controlling Movement

### Step 1: Initialization

Power on the controller using the integrated power switch.

Check the LCD screen to ensure the system is displaying the current settings for speed, distance, and delay time.

### Step 2: Setting Operational Parameters

Adjust the leftmost potentiometer knob to set the desired speed of the cart (ft/min).

Use the middle potentiometer knob to set the desired distance of movement (inches).

Set the delay time between movements using the rightmost potentiometer knob (seconds).

### Step 3: Directional Control

For individual track control, use the three-way momentary switches to set the left and right tracks to move forward, backward, or remain stationary.

For synchronized movement, use the three-way maintained switch to control both tracks together, selecting forward, backward, or off.

### Step 4: Operation

Monitor the real-time settings on the LCD screen and make any necessary adjustments to the speed, distance, or delay time.

Utilize the wireless communication feature to ensure the motor controllers receive accurate commands without the need for wired connections.

### Step 5: Power Management

After completing the welding or grinding tasks, power off the controller using the integrated power switch to conserve energy and prepare the system for the next operation.

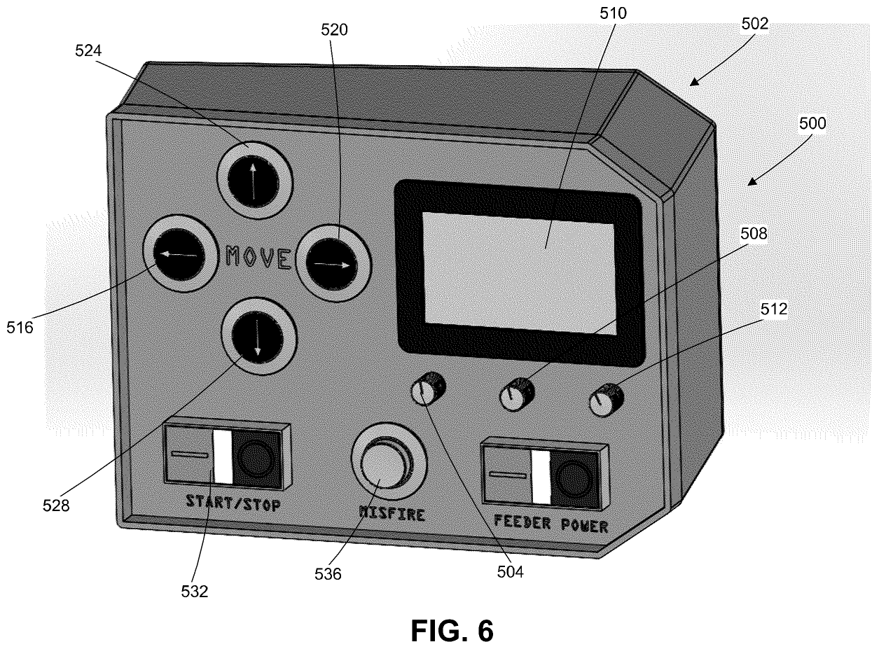

Referring to FIGS. 6-10, an alternative system 500 for controlling the movement of a motorized cart 200 carrying surface grinding and shear stud welding equipment is disclosed. System 500 includes a motor controller 502, which can be mounted to the shear stud feeder 252. In iterative/automatic mode, the motor controller 502 controls the movement of the cart 200 along a work surface, such as a deck pan 112 (see FIG. 2), based on the number of studs 128 welded to the I-beam 116. The motor controller 502 displays and allows adjustment of parameters such as travel speed, distance, and stud count per row.

There are several options for the system 500 to determine that a stud has been welded. Examples include (a) a solenoid switch on a stud loader that detects the loading of a stud into a stud welding gun, (b) an electrical connection that detects activation of a trigger switch for a welding gun, and (c) a sensor (such as a hall effect sensor or a magneto-resistive sensor) that is adapted to detect an electromagnetic field generated by a stud welding gun when actively welding a stud. The system 500 may support both welding and grinding applications. The control system 500 also includes a manual mode for operating the movement of the system 500.

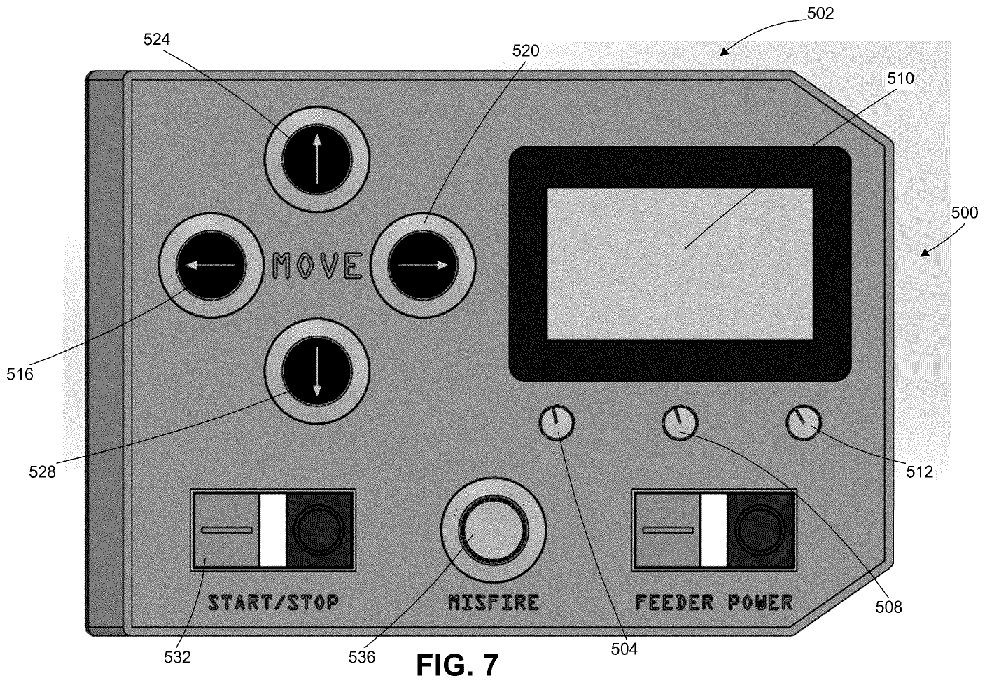

As shown in FIGS. 6 and 7, the motor controller 502 features three potentiometer knobs: a left knob 504 for setting the cart's speed (e.g., in feet per second), a center knob 508 for setting the travel distance (e.g., between predefined grinding or welding sites on the I-beam 116, measured in inches), and a right knob 512 for selecting the number of studs to be welded before the cart advances to the next row when operating in iterative mode. Instead of relying on a timed delay, the control system 500 now advances the cart 200 to the next row after detecting that the predetermined number of studs, e.g., three studs, have been welded, based on input from the welding equipment (not shown) or grinding equipment. The rows of studs may be arranged along the top surface of the I-beam and oriented in a direction that is transverse to the longitudinal axis of the I-beam. For example, the beam 116 shown in FIG. 2 has three studs per row. A display screen 510 on the motor controller 502 may provide real-time feedback, including the selected speed and distance, the number of studs 128 remaining in the current row, the total studs per row, and a cumulative daily stud count. The system may also provide other types of real-time feedback to the operator, such as alerts, status indicators, or performance metrics related to the stud welding or grinding process.

The motor controller 502 includes a Start/Stop button 532 that allows the user to activate or deactivate the iterative mode. To improve accuracy in tracking welds, the motor controller 502 also incorporates a misfire detection system. This system includes a “Misfire” button 536, which the operator can press to indicate that a weld attempt failed or did not complete properly. Pressing this button 536 prevents the control system 500 from incorrectly counting a misfire as a completed weld, ensuring that the cart 200 only advances after the correct number of successful welds.

The motor controller 502 may also include manual controls enabling the operator to directly control the cart 200 movement. The manual controls may include a left manual switch 516, a right manual switch 520, a forward manual switch 524 and a backward manual switch 528. Actuation of the switches either alone or in combination enables the operator to control movement of the motorized conveyor cart 200 in a linear or non-linear direction at a predetermined speed set by the operator to allow the operator to adjust the position of cart 200 as the operator moves from one pre-defined welding site to the next on the I-beam 116.

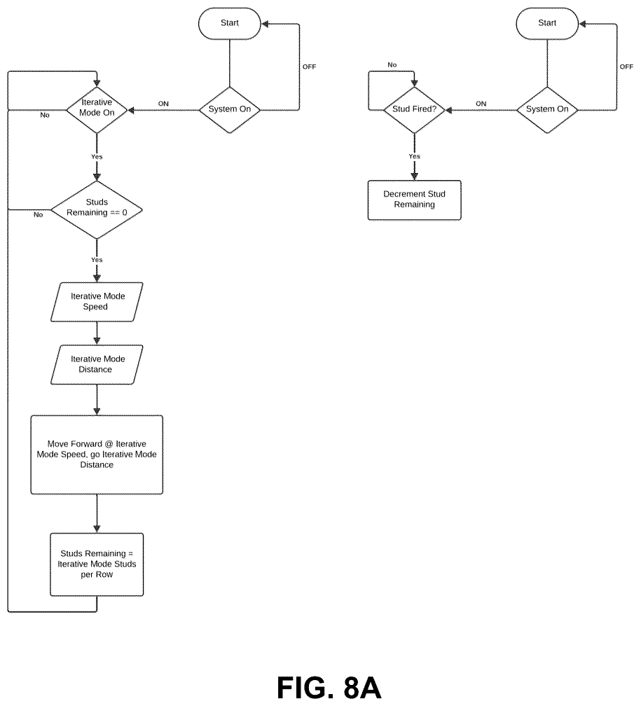

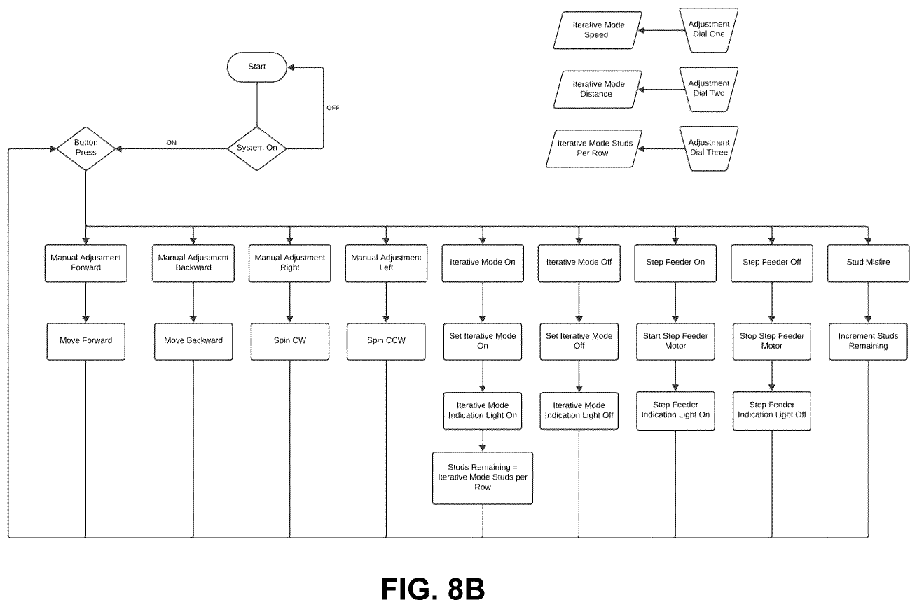

Referring now to FIGS. 8A and 8B, there is shown a logic flow diagram illustrating both the manual and iterative modes of operation of the control system 500. In iterative mode, the control system 500 executes a pre-programmed stud-loading sequence based on user-defined settings including movement speed, travel distance per cycle, and studs per row. Once activated, the motorized cart 200 advances step-by-step at the set speed and distance, dispensing a stud 128 at each interval while decrementing an internal counter. The cycle continues until the designated stud count reaches zero, at which point the sequence halts. Visual indicators at 532 reflect whether iterative mode is actively running, allowing the operator to monitor status with minimal manual oversight. Iterative mode supports high-efficiency, repeatable stud placement without requiring real-time intervention. Manual mode provides direct operator control over the cart's positioning functions. Using directional commands, forward, backward, left, and right, the operator can move the cart 200 precisely as needed. Additional controls for clockwise (CW) and counterclockwise (CCW) rotation enhance positional flexibility. The manual adjustment buttons 516, 520, 524, and 528 override automated behavior, allowing fine-tuned corrections or placement decisions outside of the automated cycle. Manual mode is particularly useful for initial setup, troubleshooting, or non-uniform stud placement scenarios that require human judgment. Together, these two modes, manual and iterative, offer flexibility between fully automated sequences and hands-on control, making the cart 200 adaptable for a wide range of operational environments.

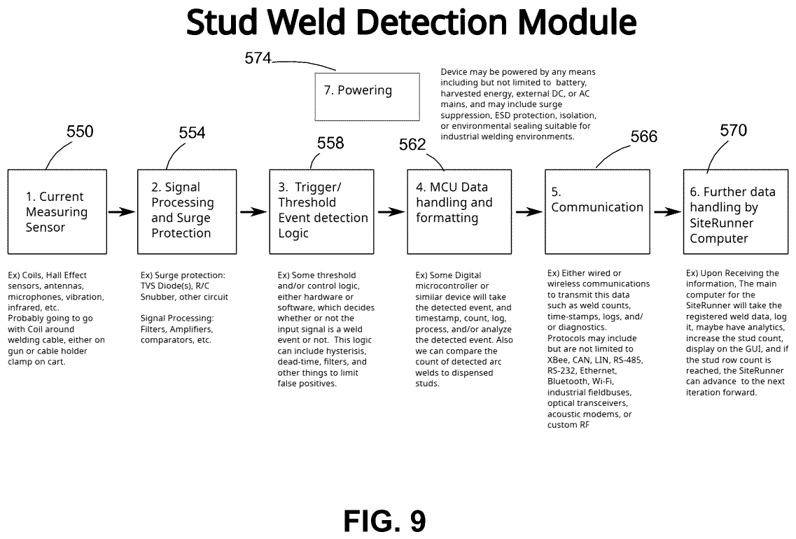

FIG. 9 shows the details of a stud welding detection module which is designed to accurately detect and document stud welding events during operation of the control system when in iterative mode. As stated above, detection of a completed stud weld can occur through one of three mechanisms: first, by receiving an input signal from a solenoid that senses when a stud is driven into the collet of the stud welder; second, by receiving an input signal from the trigger of the stud welder that indicates activation of the welding operation; and third, by sensing an electromagnetic spike that naturally occurs during the welding process. The module employs a current measuring sensor 550, such as a coil wrapped around the welding cable to detect these various types of input signals or electromagnetic signatures. To ensure reliable performance, the system 500 includes surge suppression 554 (e.g., TVS diodes, snubbers) and signal conditioning components like filters and amplifiers. A threshold detection logic circuit 558, implemented in hardware or software, interprets the processed signals and distinguishes valid weld events using features such as hysteresis and dead-time to minimize false positives. A microcontroller 562 handles event timing, counting, and formatting, comparing the detected weld data against the expected stud dispensing operations. The module then transmits this data via supported wired or wireless communication protocols 566, including but not limited to RS-485, CAN, Ethernet, Wi-Fi, and Bluetooth. A SiteRunner computer 570 receives and logs the information, displays weld counts and timing data via a graphical interface, and advances the welding process automatically when predetermined row counts are achieved. The system accommodates multiple power sources 574, e.g., battery, harvested energy, AC mains, and is designed for durability and reliability in rugged welding environments.

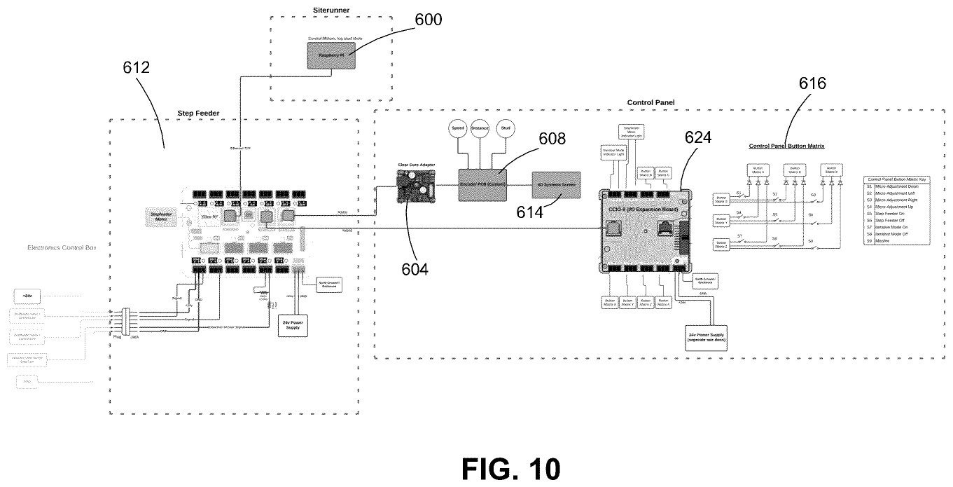

FIG. 10 illustrates the control and signal architecture for the alternative control system for the stud loading and welding system. It outlines the interconnected components responsible for feeding, sensing, controlling, and logging stud weld operations. At the heart of the system is a control unit 600 which manages motor controls and records stud weld data. It communicates with various peripherals via ethernet TCP, RS-232, and XBee RF wireless links. A clear core adapter 604 and custom encoder PCB 608 handle motion control and feedback for the step feeder 612, a mechanism that advances individual weld studs 128 into the correct position. A 4D Systems touch screen 614 provides a user interface, while a control panel button matrix 616 allows manual adjustments and operation modes. This matrix includes controls for micro adjustments in multiple directions, toggling the step feeder on or off, enabling or disabling iterative modes, and indicating misfire events.

Power is supplied via a dedicated 24V power supply 620, distributing energy to components such as valve control lines, indicator lights, and sensors. Inductive sensors 624 are used to detect stud position and limit endpoints. The system incorporates I/O expansion boards 624 (CCIO-8) to accommodate additional input signals from the various button matrices labeled X, Y, Z, A, B, and C. Environmental protection measures, such as earth grounding and enclosure shielding, are in place to ensure safe and reliable operation.

Although described primarily in the context of stud loading and welding, the system may also be configured for grinding weld sites. In this mode, the motorized cart 200 can be programmed to travel between designated locations on the I-beam 116 where grinding is required, using the same control architecture and adjustable parameters such as speed, distance, and site count to automate and coordinate the grinding process efficiently.

All examples and conditional language recited herein are intended for pedagogical purposes to aid the reader in understanding the principles of the present invention and the concepts contributed by the inventor in furthering the art. As such, they are to be construed as being without limitation to such specifically recited examples and conditions. Moreover, all statements herein reciting principles, aspects, and implementations of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It is to be understood that the implementations described herein are merely exemplary and that a person skilled in the art may make many variations and modifications without departing from the spirit and scope of the invention. All such variations and modifications are intended to be included within the scope of the invention, as defined by the following claims.

1.-19. (canceled)

20. A method for operating a motorized cart configured to carry stud welding and/or grinding equipment along a workpiece, the method comprising:
a. initializing a controller configured to control movement of the motorized cart along the workpiece;
b. receiving, via a user interface operatively connected to the controller, one or more operational parameters including at least a travel speed, a travel distance, and a stud count per row, wherein each row comprises a defined set of positions on the workpiece at which a predetermined number of stud welds are to be performed;
c. executing an iterative mode in which the controller:
(i) detects each completed stud weld using one or more input signals indicative of a performed weld operation; and
(ii) advances the motorized cart from a current row to a next row along the workpiece after detecting that the predetermined number of stud welds have been performed in the current row; and
d. displaying, on a display screen, real-time information relating to the operation of the motorized cart, including data associated with travel and stud welding progress.

21. The method of claim 20, wherein detecting a completed stud weld comprises receiving an input signal from a solenoid configured to detect when a stud is driven into a collet of the stud welder.

22. The method of claim 20, wherein detecting a completed stud weld comprises receiving an input signal from a trigger of the stud welder indicating activation of the welding operation.

23. The method of claim 20, wherein detecting a completed stud weld comprises sensing an electromagnetic spike produced during the welding operation.

24. The method of claim 20, further comprising activating a misfire button to indicate that a weld attempt has failed or was incomplete, wherein activation of the misfire button prevents the controller from counting the weld attempt as a completed stud weld in the iterative mode.

25. A control system for operating a motorized cart configured to carry stud welding and/or grinding equipment along a workpiece, the control system comprising:
a. a controller configured to control movement of the motorized cart along the workpiece;
b. a user interface operatively connected to the controller and configured to allow adjustment of one or more operational parameters, including at least a travel speed, a travel distance, and a stud count per row, wherein each row comprises a defined set of positions on the workpiece at which a predetermined number of stud welds are to be performed;
c. an iterative mode executable by the controller, wherein the controller
(i) detects each completed stud weld using one or more input signals indicative of a performed weld operation; and
(ii) advances the motorized cart from a current row to a next row along the workpiece after detecting that the predetermined number of stud welds have been performed in the current row; and,
d. a display configured to provide real-time information relating to the operation of the motorized cart, including data associated with travel and stud welding progress.

26. The control system of claim 25, wherein the one or more input signals comprise a solenoid sensor configured to generate the input signal when a stud is driven into a collet of a welding gun.

27. The apparatus of claim 25, wherein the one or more input signals comprise a welding gun trigger sensor configured to generate the input signal in response to activation of the welding operation.

28. The apparatus of claim 25, wherein the one or more input signals comprise an electromagnetic sensor configured to detect an electromagnetic spike produced during the welding operation and to generate the input signal in response to the detected spike.

29. A control system for operating a motorized cart configured to carry a stud grinder along a workpiece, the control system comprising:
a. a controller configured to control movement of the motorized cart along the workpiece;
b. a user interface operatively connected to the controller and configured to allow adjustment of one or more operational parameters, including at least a travel speed, a travel distance, and a stud grinding count per row;
c. an iterative mode executable by the controller, wherein the controller:
(i) advances the motorized cart along the workpiece to a next row based on a number of grinding operations completed at stud sites along a current row; and
(ii) detects completion of each grinding operation at a stud site using one or more input signals indicative of successful performance of the grinding operation; and
d. a display configured to provide real-time information relating to the operation of the motorized cart, including data associated with travel and grinding progress.

30. The method of claim 29, wherein detecting that a grinding operation has been completed comprises receiving an input signal from a grinder trigger mechanism indicating activation or deactivation of the grinding operation.
